(19) United States
(12) Patent Application Publication
(10) Pub. No.: US 2025/0392684 A1
(43) Pub. Date: Dec. 25, 2025

(54) Vehicle Video Recording Device and Method of Controlling the Same

(71) Applicants: HYUNDAI MOTOR COMPANY, Seoul (KR); KIA CORPORATION, Seoul (KR)

(72) Inventors: Dong Hyuk Jeong, Hwaseong-si (KR); Kyoung Jun Kim, Hwaseong-si (KR); Seok Ju Yeom, Hwaseong-si (KR); Jeong Muk Kang, Hwaseong-si (KR); Sung Hwan Jun, Hwaseong-si (KR); Joo Am Baek, Hwaseong-si (KR)

(73) Assignees: HYUNDAI MOTOR COMPANY, Seoul (KR); KIA CORPORATION, Seoul (KR)

(21) Appl. No.: 18/956,432

(22) Filed: Nov. 22, 2024

(30) Foreign Application Priority Data
Jun. 19, 2024 (KR) 10-2024-0079733

(51) Int. Cl. H04N 7/18; H04N 5/77

(52) U.S. Cl. CPC H04N 7/188; H04N 5/77

(57) ABSTRACT

Disclosed is a video recording device for a vehicle including a sensor configured to detect a motion of an external object around the vehicle, a camera configured to record the surroundings of the vehicle, and a controller configured to determine whether to start recording by the camera based on a result of the detecting, wherein the controller is configured to receive motion information of the external object from the sensor and transmit a wake-up command to the camera when the external object is determined to enter a first area from a second area within a set time.

### CROSS-REFERENCE TO RELATED APPLICATION(S)

This application claims the benefit of Korean Patent Application No. 10-2024-0079733, filed on Jun. 19, 2024, which is hereby incorporated by reference as if fully set forth herein.

### TECHNICAL FIELD

The present disclosure relates to a video recording device for a vehicle and a method of controlling the video recording device.

### BACKGROUND

A video recording device for a vehicle refers to a device configured to record videos of, for example, a vehicle that is traveling or parked.

The video recording device may generally be referred to as a driving video recording device because it is intended mainly to acquire videos or images of an accident or the like that may occur during driving.

To acquire videos or images, the video recording device may (e.g., basically) include a controller, a memory for storing videos or images, and a camera for capturing and recording videos or images.

In general, the video recording device may store a video of the surroundings of a vehicle while the vehicle is traveling, along with data on driving of the vehicle at a time corresponding to the video and, when the occurrence of a set event is detected even while the vehicle is parked, record a video according to the already input settings.

The video recording device for a vehicle, also referred to as a black box (or a dash camera), was initially provided (e.g., only) as an external device, but has recently been embedded as a built-in device in a vehicle before the vehicle is released from a factory.

Such a built-in camera (or simply a built-in cam) may be more effective than the external one in terms of access to driving data of a host vehicle and association with other controllers and may thus be expected to be further increasingly used.

The video recording device may perform always-on recording and event-based recording while a vehicle is traveling and parked, and may interwork with an audio-video-navigation (AVN) system to configure the system and view stored videos or images.

Currently, some video recording devices for a vehicle perform always-on recording for a set period of time, which may increase memory usage and cause rapid battery drain. This battery consumption may affect fuel economy and battery aging, and thus there may be a (e.g., limited) recording time during parking due to limited battery capacity. Therefore, it may be beneficial to develop a video recording system for a vehicle that may operate for a (e.g., long) time with low power.

### SUMMARY

An object of the present disclosure is to provide a parking motion detection technique by which a video recording system for a vehicle may operate to record motions while the vehicle is parked (e.g., parking recording), for a long time with a limited amount of power, and a radar, lidar, and the like may be employed as a sensor for detecting such motions.

An object of the present disclosure is to provide a video recording method for a vehicle that may, when a movement of an external object is detected by a sensor and the external object is determined to enter a set area within a set time, transmit a wake-up command to a camera and allow the camera to start recording a video, thereby operating for a (e.g., long) time with low power.

The technical objects to be achieved by the present disclosure are not limited to those described above, and other technical objects not described above may also be clearly understood by a person of ordinary skill in the art from the following description.

According to at least one embodiment of the present disclosure, there is provided a video recording device for a vehicle, including a sensor configured to detect a motion of an external object around the vehicle, a camera configured to record surroundings of the vehicle, and a controller configured to receive motion information of the external object from the sensor and, based on a determination that the external object is to enter a first area from a second area within a set time, transmit a wake-up command to the camera.

According to at least one embodiment, the controller may be further configured to transmit a recording start command along with the wake-up command.

According to at least one embodiment, the controller may be further configured to, after the recording is started, based on a determination that the external object is within the first area or is to enter the first area from the second area, control the camera to continue the recording, or based on a determination that the external object is not in the first area or is not to enter the first area from the second area, control the camera to end the recording.

According to at least one embodiment, the controller may be further configured to, in response to the vehicle or the video recording device entering into a parking mode, control the sensor to be turned on (ON), and control the camera and the controller to be switched to a sleep mode or be turned off (OFF).

According to at least one embodiment, the controller may be further configured to set the first area to exclude a false detection prevention area of the sensor.

According to at least one embodiment, the controller may be further configured to set the first area and the set time according to parameter information set by a user.

According to at least one embodiment, the parameter information may include at least one of a first parameter set based on a sensitivity and a second parameter set based on a shape classification of the external object.

According to at least one embodiment, the shape classification of the external object may include at least one of a person, a vehicle, an animal, or a bicycle.

According to at least one embodiment, the parameter information may include a detection distance parameter associated with a range of the first area, a false detection range parameter associated with a false detection prevention area of the first area, and a time parameter associated with the set time.

According to at least one embodiment, the controller is further configured to determine the set time as predicted to be taken for the external object to enter the first area from the second area.

According to at least one embodiment, the determination that the external object is to enter the first area from the second area within the set time may be based on a velocity of the external object.

According to at least one embodiment, there is provided a video recording device for a vehicle, including a sensor configured to detect a motion of an external object around the vehicle, a camera configured to record surroundings of the vehicle, and a controller configured to determine to start the recording in response to the external object being detected in a first area, and wake up the camera based on a determination that the external object is to enter the first area from a second area within a set time.

According to at least one embodiment of the present disclosure, there is provided a method of controlling a video recording device for a vehicle, the method including starting, by a controller, a parking mode in the video recording device, receiving, by the controller, information of a motion of an external object around the vehicle from at least one sensor of the vehicle, and transmitting, by the controller, a wake-up command to a camera based on a determination that the external object is to enter a first area from a second area within a set time.

According to at least one embodiment, transmitting the wake-up command to the camera may include transmitting a recording start command along with the wake-up command.

According to at least one embodiment, the method may further include, after the recording being started, based on a determination that the external object is within the first area or is to enter the first area from the second area, controlling the camera to continue the recording, or based on a determination that the external object is not in the first area or is not to enter the first area from the second area, controlling the camera to end the recording.

According to at least one embodiment, the method may further include, in response to the vehicle or the video recording device entering into a parking mode, controlling the sensor to be turned on (ON), and controlling the camera and the controller to be switched to a sleep mode or be turned off (OFF).

According to at least one embodiment, the method may further include setting the first area to exclude a false detection prevention area of the sensor.

According to at least one embodiment, the method may further include setting the first area and the set time according to parameter information set by a user.

According to at least one embodiment, the parameter information may include at least one of a first parameter set based on a sensitivity and a second parameter set based on a shape classification of the external object.

According to at least one embodiment, the method may further include determining to start recording by the camera in response to an external object being detected within the first area.

According to at least one embodiment of the present disclosure described herein, the video recording device and method for a vehicle may, when a movement of an external object is detected by a sensor and the external object is determined to enter a set area within a set time, transmit a wake-up command to a camera and allow the camera to start recording, thereby increasing an operating time of a parking recording function and effectively operating a storage memory.

According to at least one embodiment of the present disclosure described herein, the video recording device and method may be implemented (e.g., only) with a modification to software for a (e.g., typical) video recording device without additional hardware.

The effects that can be achieved from the present disclosure are not limited to those described above, and other effects not described above may also be clearly understood by a person of ordinary skill in the art from the following description.

### BRIEF DESCRIPTION OF THE DRAWINGS

FIG. 1 is a diagram illustrating a configuration of a video recording device for a vehicle and a vehicle including the video recording device according to an embodiment of the present disclosure.

FIGS. 2A, 2B1, and 2B2 are diagrams illustrating examples of the division and variation of a sensor detection area according to an embodiment of the present disclosure.

FIG. 3 is a flowchart illustrating a flow of operations performed by a video recording device for a vehicle according to an embodiment of the present disclosure.

FIGS. 4A, 4B, 4C, and 4D are diagrams illustrating example operations of a video recording device for a vehicle based on a result of detecting an external object in a first area according to an embodiment of the present disclosure.

FIG. 5 is a table illustrating an example of applying parameters classified by dividing setting steps by sensitivity when setting a motion sensor detection reference based on which a camera is to be woken up and recording is started, according to an embodiment of the present disclosure.

FIG. 6 is a table illustrating an example of applying parameters classified by the shape of an external object when setting a motion sensor detection reference based on which a camera is to be woken up and recording is started, according to an embodiment of the present disclosure.

### DETAILED DESCRIPTION

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the ease of explanation, and thus the terms per se do not necessarily have different meanings or functions. The terms “module,” “unit,” and/or “-er/or” do not necessarily mean (e.g., require) physical separation.

Although terms including ordinal numbers, such as, “first,” “second,” and the like, may be used herein to describe various elements, the elements are not limited by these terms. These terms are (e.g., only) used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, computation, decision, and the like that are may be beneficial (e.g., necessary) for controlling a function assigned thereto.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

The processor may be electrically connected to the memory, and the processor may load and record data from the memory. The memory and the processor may be integrated or may be physically separated.

Hereinafter, embodiments of the present disclosure will be described in detail with reference to the accompanying drawings.

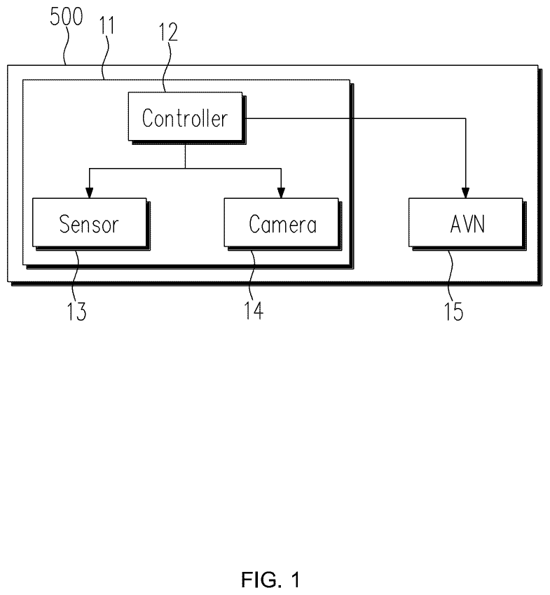

FIG. 1 is a diagram illustrating a configuration of a video recording device for a vehicle and a vehicle including the video recording device according to an embodiment of the present disclosure.

Each component shown in FIG. 1 is provided for illustrative purposes (e.g., only), and it is to be noted that, in actual implementations, more components may be included in a vehicle 500 and a video recording device 11 for a vehicle. In particular, the video recording device 11 according to an embodiment of the present disclosure is provided in an embedded type but is not necessarily limited thereto.

Referring to FIG. 1, according to an embodiment of the present disclosure, the video recording device 11 for a vehicle may include a motion detection sensor 13 configured to detect a motion of an external object around the vehicle 500, a camera 14 configured to record the surroundings of the vehicle 500, and a controller 12 configured to determine whether to start recording by the camera 14 based on a result of the detection. In addition, there may be an audio-video-navigation (AVN) system 15 communicatively connected to the controller 12.

The motion detection sensor 13 configured to detect a motion of an external object around the vehicle 500 may include, for example, at least one of a radar, lidar, ultrasonic, or infrared sensor, and may detect a distance between the vehicle 500 and an external object that moves before or behind the vehicle 500. The motion detection sensor 13 may include any types of sensors that may detect motions of external objects outside the vehicle 500. It is to be noted that, although the motion detection sensor 13 dedicated to the video recording device 11 may be used, a radar sensor or the like installed in the vehicle 500 may also be used.

A signal detected by the motion detection sensor 13 may be a reference based on which the controller 12 may determine whether to start recording, and the reference may include, for example, detection distance information, time information, or the like, which may be set by a user.

The camera 14 may include, but is not necessarily limited to, a front camera and a rear camera. The front camera may be installed to capture a video of an area before the vehicle 500, and the rear camera may be installed to capture a video of an area behind the vehicle 500.

For example, the front camera may be installed on a windshield in the cabin of the vehicle 500 near a room mirror, and the rear camera may be installed on a rear window or rear bumper of the cabin of the vehicle 500.

The front camera and the rear camera may support any one of the definitions, for example, high-definition (HD), full HD (FHD), and quad HD (QHD) image quality. It is to be noted that the front camera and the rear camera may not provide the same image quality, and a camera of an advanced driver-assistance system (ADAS) of the vehicle 500 may be used.

In addition, the camera 14 may have an aperture value of F2.0 or less, preferably F1.6 or less. A lower aperture value may allow more light to be gathered, resulting in brighter recordings. In addition, an image tuning technique may be applied to minimize noise and light loss, enabling clear recording even in a dark environment.

The controller 12 may control other components to perform always-on recording while driving (also herein “always-on driving recording) and always-on recording while parked (also herein “always-on parking recording) and start the recording based on a signal detected by the motion detection sensor 13. The controller 12 may also receive, from the user, an input for setting a recording start condition through a user menu.

The AVN system 15 may be communicatively connected to the controller 12 (e.g., a built-in camera controller) directly or through a controller of the vehicle 500, and an AVN screen may function as a user interface (UI) for receiving various settings parameters of the video recording device 11 (e.g., a built-in cam system) selected by the user.

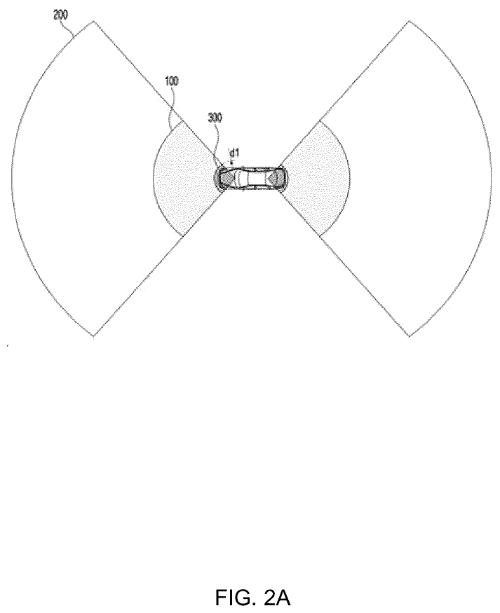

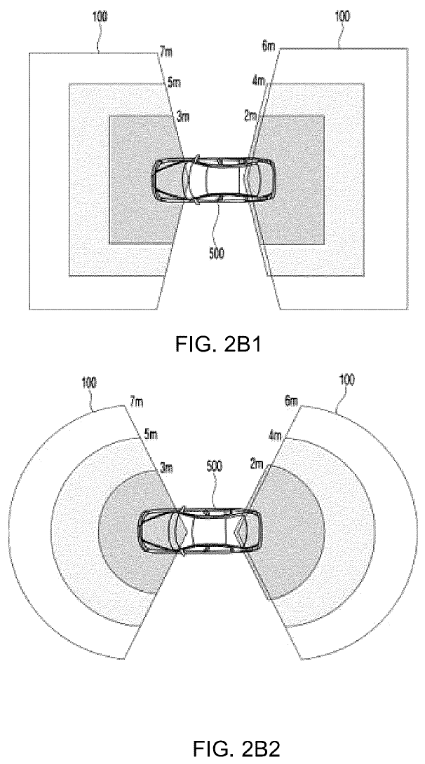

FIGS. 2A, 2B1, and 2B2 are diagrams illustrating examples of the division and variation of a sensor detection area according to an embodiment of the present disclosure.

Referring to FIG. 2A, a first area 100 may be, for example, a radial area based on a longitudinal and lateral distance of the vehicle 500 in a video capturing direction of the camera 14 relative to the center of the camera 14, which may correspond to a distance detection parameter based on distance information. Although front and rear areas are illustrated, other areas, such as left and right areas may also be applied. In addition, the first area 100 may be set to exclude a false detection prevention area 300 that is determined as within a certain distance d1 or less, in order to prevent false detection of the motion detection sensor 13, which may correspond to a false detection range parameter.

In addition, a set time may be based on time information about a time predicted to be used for an external object to enter the first area 100 from a second area 200, which may correspond to a time parameter. These parameters may be variable and set by the user. FIGS. 2B1 and 2B2 illustrate examples of varying and setting the distance detection parameter by the user. A first area (e.g., the first area 100) of the motion detection sensor 13 may be of various shapes as shown, but the shape of the first area is not limited to the shapes shown.

The second area 200 may be an area that excludes the first area 100 from an (e.g., entire) coverage area that is set to be detected by the sensor 13. That is, the second area 200 may be an area having a larger detection distance than the first area 100. For example, currently, a lidar may detect an external object up to a distance of 30 meters (m) to estimate a speed, direction, or the like of the object, and the detection distance parameter of the first area 100, which is the recording reference, may be set at the level of 10 to 15 meters. This is provided (e.g., only) as an example, and it is apparent to a person of ordinary skill in the art that other specific configurations may be applicable.

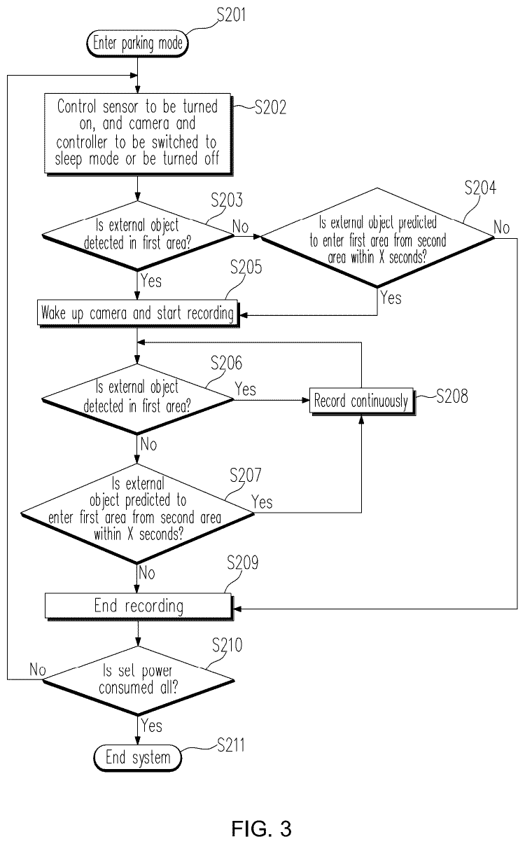

FIG. 3 is a flowchart illustrating a flow of operations performed by a video recording device for a vehicle according to an embodiment of the present disclosure.

Referring to FIG. 3, a video recording device (e.g., the video recording device 11) for a vehicle may enter a parking mode in step S201.

The controller 12 may then command the sensor 13 to be turned on and the camera 14 and the controller 12 to enter a sleep mode or be turned off, in step S202. This may be performed to minimize battery consumption of the vehicle 500 in the parking mode.

The controller 12 may check whether an external object is detected within a first area 100 in step S203 and, when the external object is within the first area 100, may wake up the camera 14 and start recording in step S205.

After checking whether the external object is detected within the first area 100 in step S203, when the external object is not detected within the first area 100, the controller 12 may predict whether the external object is to enter the first area 100 from a second area 200 within a set time in step S204. In this case, predicting whether the external object is to enter the first area 100 within the set time may be performed based on a speed and direction of the external object. When the external object is predicted to enter the first area 100 within the set time, the camera 14 may be woken up and the recording may be started in step S205. When the external object is not predicted to enter the first area 100 within the set time, the recording may end in step S209.

Even after the recording has started, the controller 12 may check whether the external object is detected in the first area 100 in step S206. This step may be performed to check whether the external object is still in the first area 100 after the recording is started due to the presence of the external object in the first area 100 before the recording is started, and to check whether the external object actually enters the first area 100 when the recording is started after the entry into the first area from the second area 200 is determined.

In this case, the controller 12 may check whether the external object is detected in the first area 100 in step S206 and, when the external object is detected in the first area 100, may continue the recording in step S208. It may check whether the external object is detected in the first area 100 in step S206 and, when the external object is not detected in the first area 100, may predict whether the external object is to enter the first area 100 within a set time in step S207. When the external object is predicted to enter, the controller 12 may continue the recording in step S208. In contrast, when the external object is not predicted to enter the first area 100 within the set time, the controller 12 may end the recording in step S209.

When the recording ends in step S209, the controller 12 may check a consumption amount of set power in step S210 and, when all the set power has been consumed up, may end the system in step S211. When the set power has not been consumed yet, the controller 12 may start the step of turning on the sensor 13 to detect an external object again in step S202.

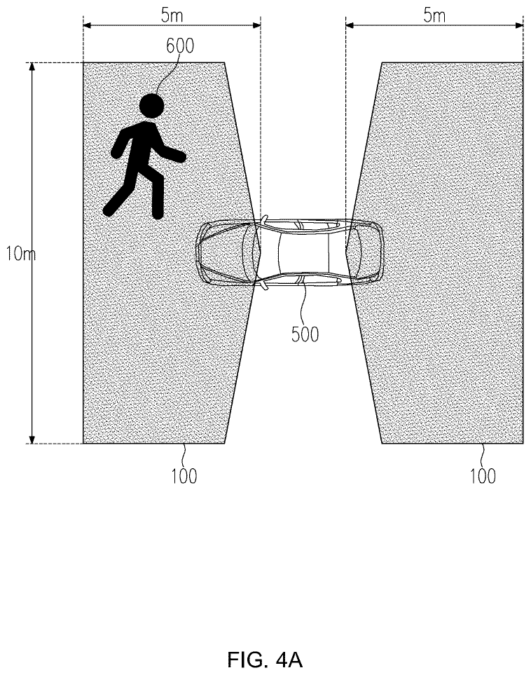

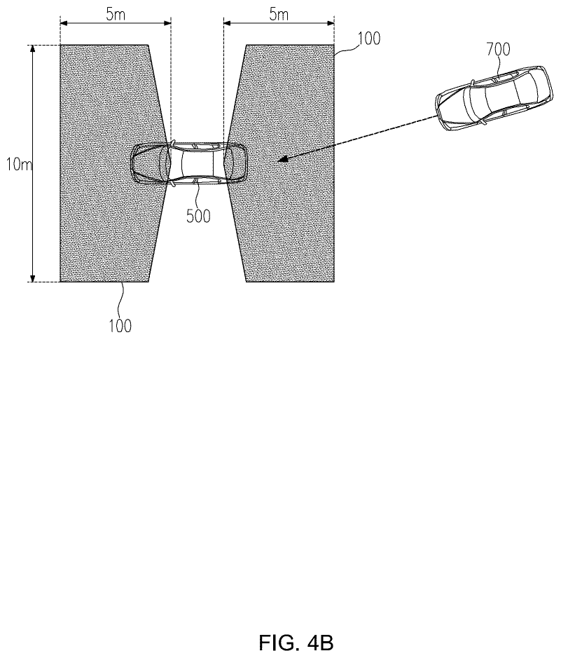

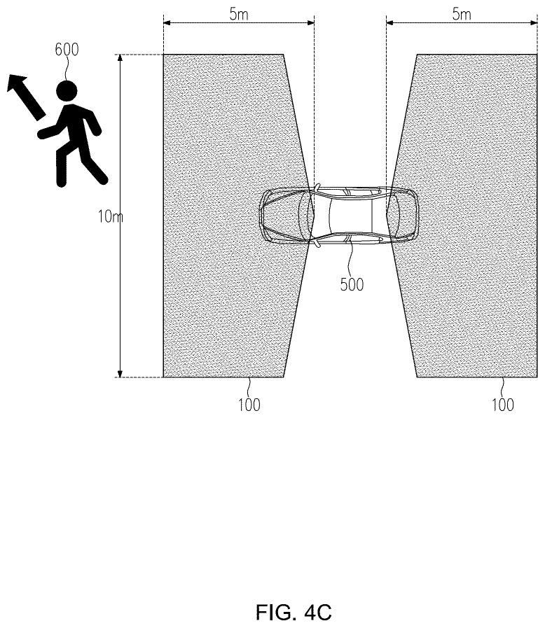

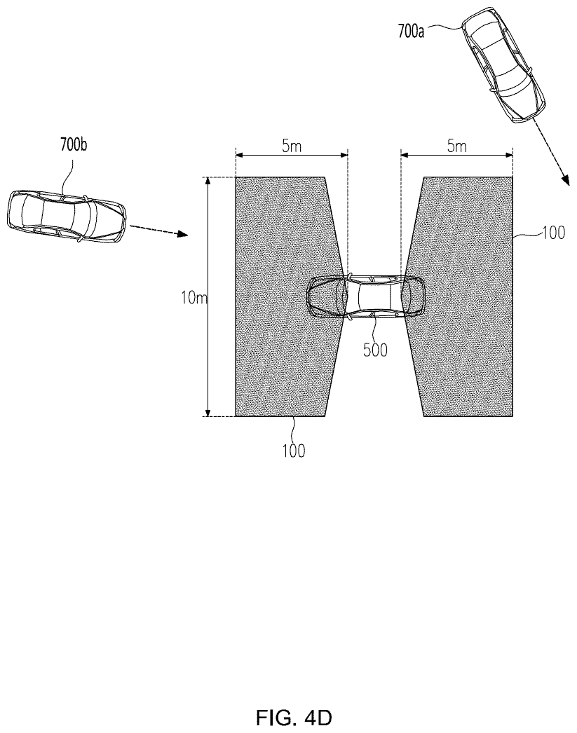

FIGS. 4A, 4B, 4C, and 4D are diagrams illustrating example operations of a video recording device for a vehicle based on a result of detecting an external object in a first area according to an embodiment of the present disclosure.

FIG. 4A illustrates an example case where a first area 100 is set by setting a detection distance parameter of the first area 100 to 5 meters (m), and a person 600, which is an external object, is detected within the first area 100. In this case, a camera may be woken up and recording may start.

FIG. 4B illustrates an example case where a first area 100 is set by setting a detection distance parameter of the first area 100 to 5 m and setting a set time, e.g., a time parameter, and a vehicle 700, which is an external object, is predicted to enter the first area 100 within the set time. This case may be a condition that wakes up a camera.

FIG. 4C illustrates an example case where a first area 100 is set by setting a detection distance parameter of the first area 100 to 5 m and setting a set time, e.g., a time parameter, and a person 600, which is an external object, is not predicted to enter the first area 100 within the set time. In this case, a camera may not be woken up.

FIG. 4D illustrates an example case where a first area 100 is set by setting a detection distance parameter of the first area 100 to 5 m and setting a set time, e.g., a time parameter, and a vehicle 700a is not heading toward the first area 100 or a vehicle 700b is heading toward the first area 100 but is not able to enter the first area 100 within the set time due to a slow moving speed. In this case, a camera may not be woken up.

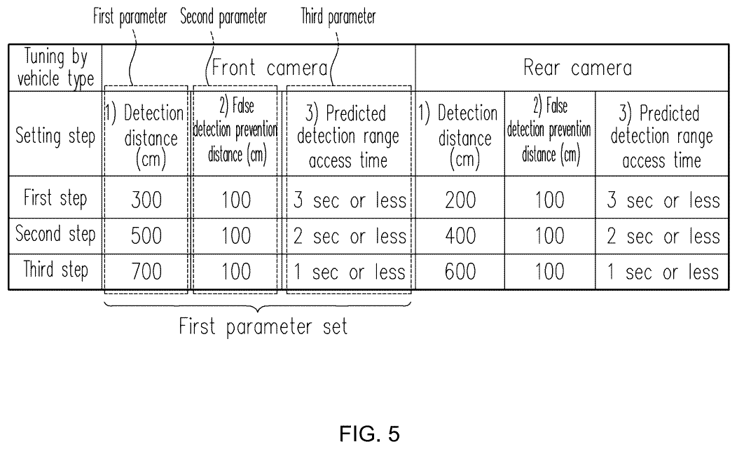

FIG. 5 is a table illustrating an example of applying parameters classified by dividing setting steps by sensitivity when setting a motion sensor detection reference based on which a camera is to be woken up and recording is started, according to an embodiment of the present disclosure.

FIG. 5 illustrates an example case where a camera (e.g., the camera 14) includes a front camera and a rear camera, and a motion detection sensor (e.g., the motion detection sensor 13) is applied to the camera 14. However, examples are not limited thereto. A first area 100 may be a radial area based on a longitudinal and lateral distance of the vehicle 500 in a video capturing direction of the camera 14 relative to the center of the camera 14, which may correspond to a distance detection parameter based on distance information. In addition, the first area 100 may be set to exclude a false detection prevention area 300 that is detected within a certain distance or less to prevent false detection of the motion detection sensor 13, which may correspond to a false detection range parameter. In addition, a set time may be based on time information about a time predicted to be used for an external object to enter the first area 100 from a second area 200, which may correspond to a time parameter. Each parameter information may be variable by the user. In this case, the distance detection parameter, the false detection range parameter, and the time parameter, which are based on sensitivity, may be defined herein as a first parameter, a second parameter, and a third parameter, respectively. The three parameters may be collectively defined as a first parameter set.

When setting the first parameter set based on sensitivity, the user may set the parameter information through a screen of the AVN system 15 in the vehicle 500. For example, the sensitivity may be divided into three levels: level 1 (insensitive), level 2 (moderate), and level 3 (sensitive). However, the example is provided for illustrative purposes (e.g., only), and it is apparent to a person of ordinary skill in the art that other specific examples may be applicable.

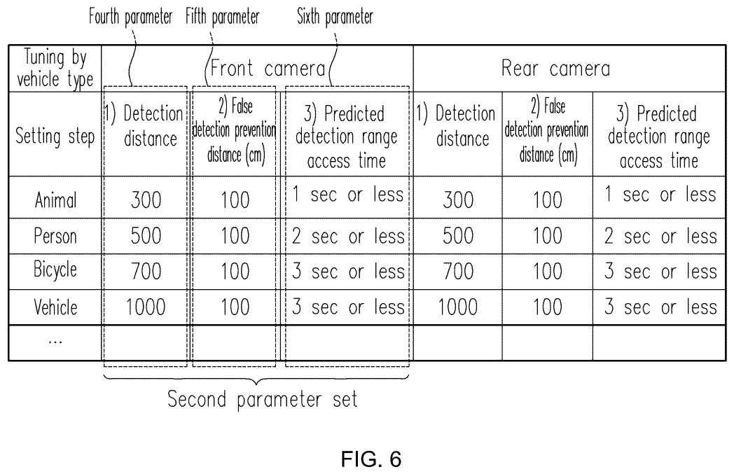

FIG. 6 is a table illustrating an example of applying parameters classified by the shape classification of an external object when setting a motion sensor detection reference based on which a camera is to be woken up and recording is started, according to an embodiment of the present disclosure.

FIG. 6 illustrates an example case where a camera (e.g., the camera 14) includes a front camera and a rear camera, and a motion detection sensor (e.g., the motion detection sensor 13) is applied to the camera 14. However, examples are not limited thereto. A first area 100 may be a radial area based on a longitudinal and lateral distance of the vehicle 500 in a video capturing direction of the camera 14 relative to the center of the camera 14, which may correspond to a distance detection parameter based on distance information. In addition, the first area 100 may be set to exclude a false detection prevention area 300 that is detected within a certain distance or less to prevent false detection of the motion detection sensor 13, which may correspond to a false detection range parameter. In addition, a set time may be based on time information about a time predicted to be used for an external object to enter the first area 100 from a second area 200, which may correspond to a time parameter. Each parameter information may be variable by the user. In this case, the distance detection parameter, the false detection range parameter, and the time parameter, which are based on the shape classification of an external object, may be defined herein as a fourth parameter, a fifth parameter, and a sixth parameter, respectively. The three parameters may be collectively defined as a second parameter set. The shape classification of an external object shape may be detected through, for example, a radar cross section (RCS) feature, which may include at least one of a person, a vehicle, an animal, and a bicycle. When dividing the steps based on the shape classification of an external object, the dividing may be performed based on a vehicle damage risk. For example, when dividing the steps in ascending order of the risk, the order may be animal, person, bicycle, and vehicle. With a person as a default value, an animal may be less likely to intentionally damage the vehicle 500, and in this case, a detection distance parameter and time parameter for recording may be set to be smaller than that in the case of a person. Also, a bicycle and a vehicle may be faster, and thus a detection distance parameter and time parameter for recording may be set to be greater than that in the case of a person.

However, this example is provided for illustrative purposes (e.g., only), and it is apparent to a person of ordinary skill in the art that other examples are applicable.

It is apparent to a person of ordinary skill in the art that the present disclosure may be embodied in other specific forms without departing from the (e.g., spirit and essential) features of the present disclosure. Accordingly, the above detailed description is not to be construed as limiting in any respect and should be considered illustrative. The scope of the present disclosure is to be determined by a reasonable interpretation of the appended claims, and all changes or modifications within the equivalents of the present disclosure are included in the scope of the present disclosure.

The method(s) according to embodiments described herein may be produced as a computer-executable program, and the program may be stored in a computer-readable recording medium. The computer-readable recording medium may include, for example, a read-only memory (ROM), a random-access memory (RAM), a compact disc ROM (CD-ROM), a magnetic tape, a floppy disk, an optical data storage device, and the like, and may also be implemented in the form of carrier waves (e.g., Internet-based transmission).

The computer-readable recording medium may be distributed across a networked computer system, such that computer-readable code may be stored and executed in a distributed manner. In addition, functional programs, code, and code segments for implementing the method(s) described herein may be readily inferred by programmers of ordinary skill in the art to which the present disclosure pertains.

It is apparent to a person of ordinary skill in the art that the present disclosure may be embodied in other specific forms without departing from the (e.g., spirit and essential) features of the present disclosure.

Accordingly, the above detailed description is not to be construed as limiting in any respect and should be considered illustrative. The scope of the present disclosure is to be determined by a reasonable interpretation of the appended claims, and all changes or modifications within the equivalents of the present disclosure are included in the scope of the present disclosure.

What is claimed is:

1. A video recording device for a vehicle, comprising:
a sensor configured to detect a motion of an external object around the vehicle;
a camera configured to record surroundings of the vehicle; and
a controller configured to
receive motion information of the external object from the sensor and, based on a determination that the external object is to enter a first area from a second area within a set time, transmit a wake-up command to the camera.

2. The video recording device of claim 1, wherein the controller is further configured to
transmit a recording start command along with the wake-up command.

3. The video recording device of claim 2, wherein the controller is further configured to:
after the recording being started, based on a determination that the external object is within the first area or is to enter the first area from the second area, control the camera to continue the recording; or
based on a determination that the external object is not in the first area or is not to enter the first area from the second area, control the camera to end the recording.

4. The video recording device of claim 1, wherein the controller is further configured to:
in response to the vehicle or the video recording device entering into a parking mode, control the sensor to be turned on (ON), and control the camera and the controller to be switched to a sleep mode or be turned off (OFF).

5. The video recording device of claim 1, wherein the controller is further configured to set the first area to exclude a false detection prevention area of the sensor.

6. The video recording device of claim 1, wherein the controller is further configured to set the first area and the set time according to parameter information set by a user.

7. The video recording device of claim 6, wherein the parameter information comprises
at least one of a first parameter set based on a sensitivity and a second parameter set based on a shape classification of the external object.

8. The video recording device of claim 7, wherein the shape classification of the external object comprises
at least one of a person, a vehicle, an animal, or a bicycle.

9. The video recording device of claim 6, wherein the parameter information comprises
a detection distance parameter associated with a range of the first area, a false detection range parameter associated with a false detection prevention area of the first area, and a time parameter associated with the set time.

10. The video recording device of claim 1, wherein the controller is further configured to determine the set time as predicted to be taken for the external object to enter the first area from the second area.

11. The video recording device of claim 1, wherein the determination that the external object is to enter the first area from the second area within the set time is based on a velocity of the external object.

12. A video recording device for a vehicle, comprising:
a sensor configured to detect a motion of an external object around the vehicle;
a camera configured to record surroundings of the vehicle; and
a controller configured to
determine to start recording in response to the external object being detected in a first area, and
wake up the camera based on a determination that the external object is to enter the first area from a second area within a set time.

13. A method of controlling a video recording device of a vehicle, the method comprising:
starting, by a controller, a parking mode in the video recording device;
receiving, by the controller, information of a motion of an external object around the vehicle from at least one sensor of the vehicle; and
transmitting, by the controller, a wake-up command to a camera based on a determination that the external object is to enter a first area from a second area within a set time.

14. The method of claim 13, wherein transmitting the wake-up command to the camera comprises transmitting a recording start command along with the wake-up command.

15. The method of claim 14, further comprising:
after the recording being started, based on a determination that the external object is within the first area or is to enter the first area from the second area, controlling the camera to continue the recording; or
based on a determination that the external object is not in the first area or is not to enter the first area from the second area, controlling the camera to end the recording.

16. The method of claim 13, comprising,
in response to the vehicle or the video recording device entering into a parking mode, controlling the sensor to be turned on (ON), and controlling the camera and the controller to be switched to a sleep mode or be turned off (OFF).

17. The method of claim 13, further comprising setting, by the controller, the first area to exclude a false detection prevention area of the sensor.

18. The method of claim 13, further comprising setting, by the controller, the first area and the set time according to parameter information set by a user.

19. The method of claim 18, wherein the parameter information comprises
at least one of a first parameter set based on a sensitivity and a second parameter set based on a shape classification of the external object.

20. The method of claim 13, further comprising,
in response to an external object being detected within the first area, determining to start recording by the camera.
